(19) United States
(12) Patent Application Publication
(10) Pub. No.: US 2014/0340865 A1
(43) Pub. Date: Nov. 20, 2014

(54) Display Backlight System

(71) Applicant: KONINKLIJKIE PHILIPS N.V., EINDHOVEN (NL)

(72) Inventors: Rifat Ata Mustafa Hikmet, Eindhoven (NL); Ties Van Bommel, Horst (NL)

(73) Assignee: Koninklijke Philips N.V., Eindhoven (NL)

(21) Appl. No.: 14/344,167

(22) PCT Filed: Sep. 26, 2012
(86) PCT No.: PCT/IB2012/055120

§ 371 Date: Mar. 11, 2014

Related U.S. Application Data
(60) Provisional application No. 61/541,143, filed on Sep. 30, 2011.

(51) Int. Cl. G02F 1/1335; F21V 9/08; F21V 8/00; F21V 9/14

(52) U.S. Cl. CPC G02F 1/133621; F21V 9/14; F21V 9/08; G02B 6/0023; G02F 1/13362; Y10S 977/95; B82Y 20/00
USPC 362/19; 977/950

(57) ABSTRACT

A lighting device is provided, comprising:
a light-emitting arrangement comprising a solid state light source capable of emitting light of a first wavelength range, and having a light outcoupling surface; and
a polarizing color converting layer (104) arranged to receive light that is outcoupled from said light outcoupling surface, and comprising i) a color converting elements (105) capable of converting light of said first wavelength range into light of a second wavelength range, and ii) at least one region of an optically anisotropic material (108), and at least one region of an optically isotropic material (109), wherein said polarizing color converting layer is capable of preferentially scattering one linear polarization direction of light received from the light-emitting arrangement. The lighting device of the invention provides improved polarization efficiency. The lighting device may be used as a backlight in a display device, e.g. LCD device.

### FIELD OF THE INVENTION

The present invention relates to backlights for display devices, in particular for LCD displays.

### BACKGROUND OF THE INVENTION

Today, various types of flat-panel displays are used in a wide variety of applications, from mobile phone displays to large screen television sets. While some kinds of flat panel displays, such as so-called plasma displays, are comprised of arrays of light emitting pixels, the majority of flat-panel displays have arrays of pixels which can be switched between states but which are unable to independently emit light. Such flat-panel displays include the ubiquitously found LCD displays. In order for such flat-panel displays to be able to display an image to a user, the pixel array must be illuminated by either a so-called backlight, in the case of a transmissive-type pixel array, or, in the case of a reflective-type pixel array, by ambient light or a so-called frontlight.

A conventional backlight is comprised of a planar light guide into which light is coupled from a light source. One face of the planar light-guide is typically modified through structuring or modification to enable outcoupling of light. The outcoupled light passes through a polarizer and subsequently passes through the pixels in the pixel array, which are in a transmissive state, and a corresponding image becomes visible to a viewer.

In order to provide a uniform backlight luminance (avoid “hot spots”), volumetric diffuser plates have been used for diffusing the light output from the light guide. However, such a diffuser impairs the efficiency and the overall brightness of the lighting device, and results in a bulky display device.

US 2006/0290253 discloses a diffuser plate or film for use in a backlight in order to increase brightness, provide more control of the viewing angle and reduce thickness compared to previous systems. The backlight comprises a diffuser plate that preferentially scatters light more in one direction than in the other direction. In addition to the light source, which may be a combination of direct lighting and edge lighting via LEDs and a lightguide, the lighting device comprises said diffuser plate, and a prismatic collimating film and a reflective polarizer on top of the light guide.

However, in spite of the system proposed in US 2006/0290253, there remains a need in the art for improved lighting devices for use e.g. as backlights in display devices, in particular with respect to system thickness and polarization efficiency.

### SUMMARY OF THE INVENTION

It is an object of the present invention to overcome this problem, and to provide a lighting device which provides improved polarization efficiency.

According to a first aspect of the invention, this and other objects are achieved by a lighting device comprising:

a light-emitting arrangement comprising a solid state light source capable of emitting light of a first wavelength range, and having a light outcoupling surface; and

a polarizing color converting layer arranged to receive light that is outcoupled from said light outcoupling surface, and comprising i) color converting elements capable of converting light of said first wavelength range into light of a second wavelength range, and ii) at least one region of an optically anisotropic material, and at least one region of an optically isotropic material, wherein the refractive index of the isotropic material matches one of the ordinary refractive index and the extraordinary refractive index of the optically anisotropic material, and mismatch the other one of said ordinary refractive index and said extraordinary refractive index of the optically anisotropic material. Due to said match and mismatch, respectively, in refractive index, the polarizing color converting layer is capable of preferentially scattering one linear polarization direction of light received from the light-emitting arrangement.

Advantageously, the lighting device of the invention provides efficient polarization of light outcoupled from e.g. a light guide, and the device may be made thin.

In embodiments of the invention, the light-emitting arrangement comprises a solid state light source and a light guide having said light outcoupling surface. The light guide further comprises a rear surface opposite said light outcoupling surface, and at least one, typically lateral, light incoupling surface. The light guide is arranged to receive light emitted by said light source via said at least one light incoupling surface, and to guide said light by total internal reflection. Optionally the light guide may further comprise outcoupling elements provided on said rear surface, in order to promote outcoupling of light from the light guide.

The isotropic material polarizing color converting layer may be non-scattering, and thus only transmit light impinging thereon.

In embodiments of the invention, a plurality of domains of optically anisotropic material may be contained in an isotropic carrier material. In such embodiments, said domains may have shape anisotropy and be uniaxially oriented, i.e. oriented such that their longitudinal axed point generally in the same direction.

Alternatively, a plurality of domains of isotropic material may be contained in an optically anisotropic carrier material showing birefringence.

In embodiments of the invention, the color converting elements may be selected from among nanoparticles of inorganic luminescent material, quantum dots, and organic luminescent material. Advantageously, such color converting elements do not produce additional scattering, which would result depolarization. Hence, in embodiments of the invention, the color converting elements may be non-scattering. In particular, the color converting elements may comprise organic luminescent molecules have a dipole moment, which provide the additional benefit of contributing to polarization.

In embodiments of the invention the polarizing color converting layer may comprise a first layer comprising the optically anisotropic material and which is arranged to receive light that is outcoupled from the light-emitting arrangement, and further comprise a second layer comprising said color converting elements, wherein said second layer is arranged in optical contact, optionally in direct optical contact and in physical contact, with said first layer.

Alternatively, in embodiments of the invention, the polarizing color converting layer may comprise a single layer comprising said isotropic and anisotropic materials as well as said color converting elements. The color converting elements may be contained in the isotropic region(s) of the polarizing color converting layer. Additionally or alternatively, at least some of the color converting elements may be contained in the optically anisotropic region(s).

In embodiments of the invention the optically anisotropic material and/or the isotropic material comprises a polymer. For example, the optically anisotropic material may comprise poly(ethylene naphthalate) (PEN) and/or poly(ethylene terephthalate) (PET).

The lighting device of the invention may advantageously be used as a backlight for a display, in particular an LCD display. Hence, the invention also relates to a backlight system comprising a lighting device as described herein.

In a further aspect, the invention relates to a display device comprising a lighting device described herein.

It is noted that the invention relates to all possible combinations of features recited in the claims.

### BRIEF DESCRIPTION OF THE DRAWINGS

These and other aspects of the present invention will now be described in more detail, with reference to the appended drawings showing embodiment(s) of the invention, in which:

FIG. 1 shows an embodiment of the lighting device of the invention.

FIG. 2 shows the polarizing color converting layer according to embodiments of the invention.

FIG. 3 shows the polarizing color converting layer according to other embodiments of the invention.

FIG. 4-5 show various embodiments of the polarizing color converting layer of FIG. 3.

FIG. 6-7 show various embodiments of the polarizing color converting layer of FIG. 2.

As illustrated in the figures, the sizes of layers, regions and/or domains may be exaggerated for illustrative purposes and, thus, are provided to illustrate the general structures of embodiments of the present invention. Like reference numerals refer to like elements throughout.

### DETAILED DESCRIPTION

As used herein, “optically anisotropic” means that the optical properties of a medium shows a dependence on the direction of propagation of light in the medium, and the state of polarization of said light within the medium can be altered. In contrast, an “optically isotropic” medium refers to a medium in which light shows no dependence on the direction of propagation, and in which the state of the polarization of light propagating within the system cannot be altered.

As used herein, “uniaxially oriented” refers to entities having axes which tend to be oriented substantially in the same direction.

As used herein, two objects being “in optical contact” means that a path of light may extend from one object to another object, optionally via another medium having refractive index similar to that of each of said objects. “Direct optical contact” is intended to mean that said path of light extends from the first object to the second object without having to pass through an intermediate medium such as air.

FIG. 1 illustrates a lighting device according to embodiments of the invention. The lighting device 100 comprises a solid state light source 101, here a light emitting diode (LED), which is arranged to emit light of a first wavelength range into a light guide plate 102. A ray of light is coupled into the light guide 102 via a small, lateral surface 102a (so-called edge-lit configuration), and is subsequently guided by total internal reflection in the in-plane direction of the light guide plate, until it is outcoupled by an outcoupling element 103 provided on the light guide rear surface 102b, and exits the light guide via the front surface 102c of the light guide plate. Over the light-emitting front surface of the light guide is arranged a polarizing color converting layer 104 which is capable of converting light of the first wavelength range into light of a second wavelength range and of preferentially scattering one linear polarization direction of light, such that the light originating from the light source 101 may be emitted, over the whole surface of the layer 104, as at least partially polarized, partially wavelength converted light. Optionally a reflector 105 may be provided on the bottom or rear side of the light guide plate, to increase light extraction via the front surface 102c of the light guide.

Alternatively, the light source may be positioned within the light guide plate, or on the rear side of the light guide (so-called back-lit configuration).

The solid state light source used in the present invention may be any suitable solid state light source used for backlighting and which is adapted to emit light of a specified wavelength range. For example, the light source may be an LED, preferably an inorganic LED, or a laser diode. Alternatively it may be an organic light emitting diode (OLED). Typically, the first wavelength range emitted by the light source is blue light e.g. light having a wavelength in the range of from 440 to 460 nm, and the light source may thus be a blue LED. In other embodiments, the first wavelength range emitted by the light source may be UV/violet light, and the light source may thus be a UV or violet LED (for example, light having a wavelength of about 405 nm can be used). In embodiments of the invention, the first wavelength range emitted by the light source is light with a high correlated color temperature, and the light source may thus be a direct phosphor converted LED i.e. a UV, violet or blue LED with a thin layer of phosphor applied thereon. For instance, light having a correlated color temperature of 20,000 K can be used.

In order to provide backlight of a desirable color, e.g. white light, the polarizing color converting layer 104 comprises at least one color converting material which is capable of converting light of the first wavelength range into light of the second wavelength range, which is in the visible range. The light source and the color converting material are selected such that a desirable color combination is obtained. Suitable wavelength range combinations are known to persons skilled in the art.

The light guide plate 102 may be a conventional light guide plate adapted to receive light via a lateral surface and emit light via the front, large area surface. The light-guide may advantageously be a planar light-guide, which guides light, through internal reflection, between oppositely located, essentially parallel faces thereof. The planar light-guide may be made of a slab of a single dielectric material or combinations of dielectric materials. Suitable dielectric materials include different transparent materials, such as various types of glass, silicone, or polymers, such as poly(methyl methacrylate) (PMMA) or polycarbonate (PC). The light guide plate may have any suitable surface area and shape, preferably corresponding to the size and shape of a display to which it is intended to provide backlight. The thickness of the light guide plate is however typically in the range of from 0.1 to 10 mm, for example from 0.2 to 5 mm.

In order to extract the light from the light guide, outcoupling elements are provided on the back surface 102b of the light guide. The outcoupling elements scatter at least part of the guided light at such angles that it is not totally internally reflected and instead is transmitted via the surface 102c. The light outcoupling elements 103 may be dots of scattering particles, e.g. titanium oxide, or a reflective material such as aluminium oxide, barium sulfate or combinations thereof, or may comprise optical structures, such as textured or prismatic elements.

It is contemplated that instead of a light guide plate, a reflective chamber may be used which spreads the light from the light source, e.g. an LED, over a larger area, to be received by the polarizing color converting layer. Alternatively, using a large area light source, such as an OLED, the light guide plate may be omitted, and light may pass directly from the large area light source to the polarizing color converting layer.

Light that exits the light guide plate is received by the polarizing color converting layer 104, which is arranged on the front side of the light guide, optionally at a small distance therefrom.

The polarizing color converting layer 104 is capable of converting light of the first wavelength range into light of a second wavelength range and of preferentially scattering one linear polarization direction of light, such that the light originating from the light source 101 may be emitted, over the whole surface of the layer 104, as at least partially polarized, partially wavelength converted light.

Without prejudice to any particular theory, polarization direction dependent scattering is observed in systems where

i) optically isotropic particles are dispersed in an optically anisotropic matrix showing birefringence, or

ii) optically anisotropic particles are dispersed in an optically isotropic matrix where the one of the optical axes of the anisotropic particles are oriented in the same direction.

Furthermore, to achieve the polarization dependent scattering, the refractive index of the optically isotropic matrix may be matched with one of the refractive indices (either the ordinary refractive index or the extraordinary refractive index) of the optically anisotropic material and is mismatched with the other refractive index (ordinary or extraordinary refractive index, respectively) of the optically anisotropic material. As a result of said mismatch (difference) in refractive index, one linearly polarized component of light becomes scattered when incident on the isotropic/anisotropic interface while the other (orthogonal) linear polarization component of light is transmitted as the light does not experience any difference in refractive index at said interface. In this way unpolarized light falling onto such system becomes polarized as one of the linear polarized components becomes scattered while the other component is transmitted.

The birefringence, defined as Δn=nₑ−nₒ, i.e. the difference between the ordinary refractive index nₒ and the extraordinary refractive index nₑ, of the optically anisotropic material is typically higher than 0.1, for example than 0.2 and optionally more than 0.3. Furthermore, the isotropic material has a refractive index nᵢ matching one of nₑ or nₒ of the isotropic material. The difference in the index matched refractive indices may be less than 0.04, typically less than 0.02 and preferably less than 0.01. Hence, as used herein, “matching refractive indices” refer to a difference in refractive index of less than 0.04, typically less than 0.02 and preferably less than 0.01. Consequently, as used herein, a “mismatch” in refractive indices refers to a difference of 0.04 or more. What is discussed herein regarding refractive indices is typically with respect to the green range of the visible spectrum of light, but is preferably true for the entire visible part of the spectrum.

Hence, the polarizing color converting layer may comprise a matrix of optically anisotropic material showing birefringence and domains of an optically isotropic material dispersed in said optically anisotropic matrix, wherein the refractive index of the isotropic material matches one of the refractive indices (either n₀ or nₑ) of the optically anisotropic material.

Alternatively, the polarizing color converting layer may comprise an optically isotropic material matrix comprising domain of anisotropic material dispersed therein, wherein the optical axes of the anisotropic domains are oriented generally in the same direction and with refractive index match/mismatch as described above.

Where the polarizing color converting layer is arranged directly on the light guide plate, the polarizing color converting layer may be attached to the light guide plate e.g. as a coating or may be glued by an optically transparent glue to the light guide (e.g. using lamination). Where the polarizing color converting layer is in direct optical contact with the light guide plate, the light outcoupling elements may be omitted. In such embodiments it might be preferable that the polarizing color converting layer is patterned or has a gradient in anisotropic scattering. Alternatively, in embodiments where the color converting layer is arranged at a distance from the light guide, the polarizing color converting layer may be attached to the light guide plate by mechanical means such that there is an intermediate air interface. For example, the polarizing color converting layer may be positioned at a certain distance from the light guide using spacers (e.g. micrometer-sized dots or rods of glass or plastic material) such that there is a predetermined air gap between the light guide and the polarizing color converting layer. Alternatively, the polarizing color converting layer may be arranged on the light guide plate by means of a thin adhesive layer provided between the light guide plate and the polarizing color converting layer, said adhesive having a low refractive index, for example lower than 1.3 or lower than 1.2.

The capability of the polarizing color converting layer 104 to preferentially scatter substantially one of the linear polarization directions of light obtained by the incorporation of an optically anisotropic material, for example in the form of a plurality of optically anisotropic domains, which may be uniaxially oriented.

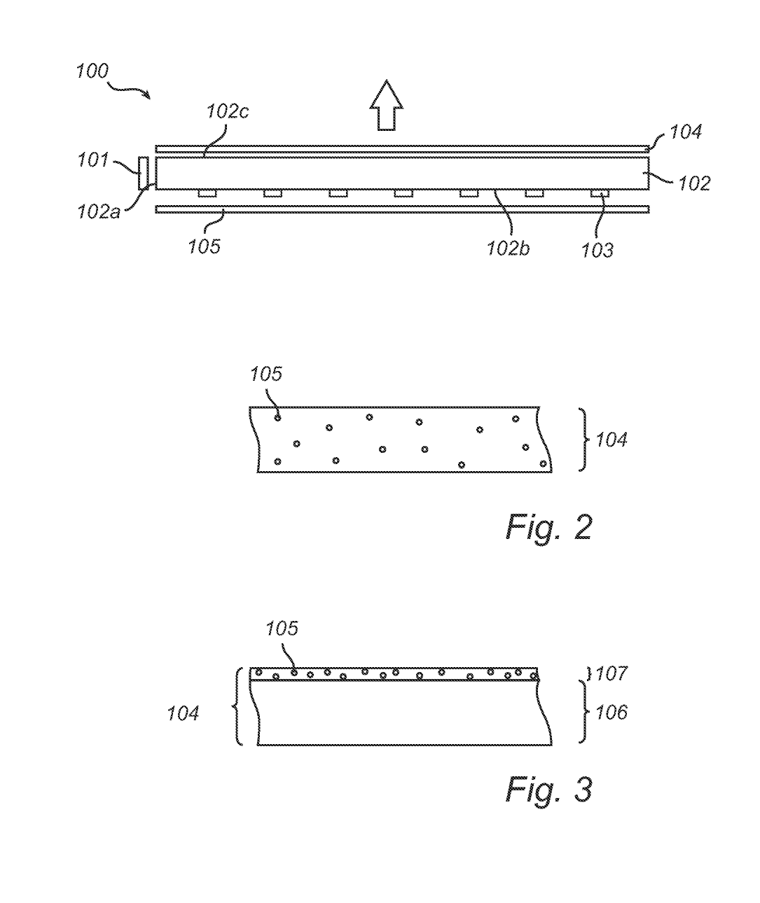

FIG. 2 illustrates a possible structure of the polarizing, color converting layer 104. As illustrated in FIG. 2, the polarizing color converting layer 104 may be formed of a single layer which is capable of preferentially scattering one linear polarization direction of light, and which also comprises a color converting material 105. FIG. 3 illustrates an alternative structure of the polarizing color converting layer 104, comprising two sublayers: one optically anisotropic scattering layer 106 capable of preferentially scattering one linear polarization direction of light, and one non-scattering color converting layer 107 arranged on the front side (light output side) of the optically anisotropic scattering layer 106 in optical contact, preferably direct optical contact, with said layer 106. It is contemplated that the embodiment of FIG. 3 may consist of additional layers, for example a second color converting layer, or one or more additional optically anisotropic scattering layers, or that a combination layer as illustrated in FIG. 2 may be combined with a purely color converting layer 107. Using more than one optically anisotropic layers may be useful where it is difficult to directly match a refractive index of the optically anisotropic layer with the refractive indices of the adjacent optical components. By using multiple optically anisotropic scattering layers with slightly different refractive indices, covering different spectral ranges of the light, and optionally in combination with refractive matched elements, the polarization selectivity for scattering may be improved.

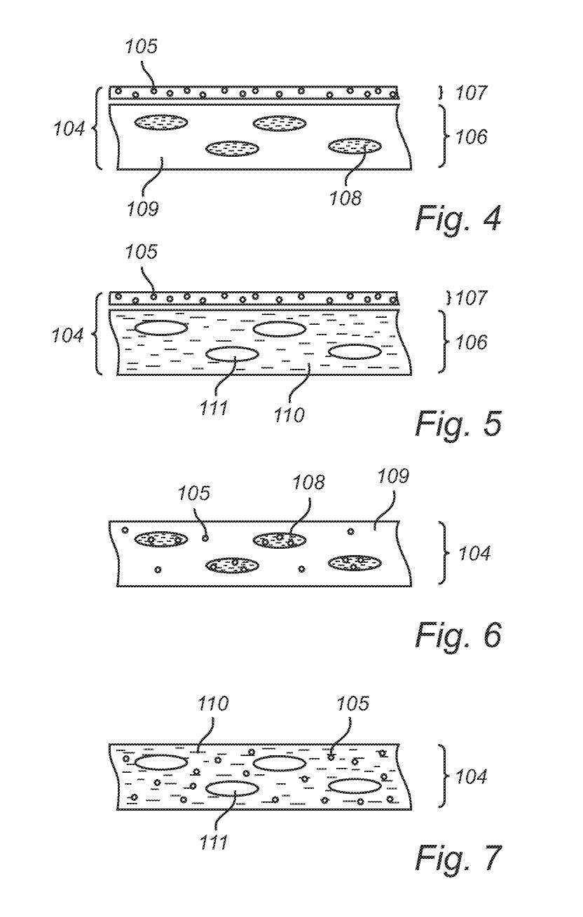

FIG. 4 shows one embodiment of the polarizing color converting layer 104 of FIG. 3 in more detail. The optically anisotropic scattering layer 106 comprises domains 108 of optically anisotropic material incorporated in an isotropic carrier material 109. The domains of anisotropic material may also have shape anisotropy, as shown in the drawings, where the domains 108 are also uniaxially oriented. The color converting layer 107 is provided on the light output side of the polarizing layer 106 as described above, in direct optical contact or in optical contact through a refractive index matching material.

Non-polarized light that is outcoupled from the light guide plate 102 is received by the color converting elements 105 and is converted into light of the second wavelength range. Without the scattering characteristics of the polarizing color converting layer, the converted light would to a large extent stay trapped within the color converting layer. As a result of optical contact between the color converting layer 107 and the optically anisotropic scattering layer 106, light is coupled out as partially polarized light. In an alternative embodiment, illustrated in FIG. 5, the polarizing layer 106 instead comprises a layer of optically anisotropic material 110 which acts as a matrix or carrier for domains 111 of isotropic material.

FIG. 6 shows an embodiment of the polarizing color converting layer 104 of FIG. 2. The polarizing color converting layer of this embodiment is an optically anisotropic scattering layer 104 which additionally comprises color converting elements 105. The optically anisotropic scattering layer comprises uniaxially oriented domains 108 of optically anisotropic material incorporated in an isotropic carrier material 109. The color converting elements 105 may be contained in the carrier material 109, or in both the carrier material 109 and the domains of optically anisotropic material 108. In an alternative embodiment, illustrated in FIG. 7, a layer of optically anisotropic material 110 acts as a carrier for domains 111 of isotropic material. As illustrated in the Figure, the color converting elements may be contained in the optically anisotropic material 110, but may alternatively or additionally also be present in the domains 111 of isotropic material.

The optically anisotropic material showing birefringence may be for example a polymeric material such as poly(ethylene naphthalate) (PEN), poly(ethylene terephthalate) (PET), liquid crystalline polymers, anisotropic polymer networks produced by polymerization of reactive liquid crystals.

The optically isotropic material may be a polymeric material, including for example acrylate polymers such as PMMA, polycarbonate and polyurethane, where the refractive index of the optically isotropic material is selected to be substantially the same as one of the refractive indices of the optically anisotropic material.

The polarizing scattering layer according to the invention may have a thickness in the range of from 0.025 to 2 mm, preferably from 0.1 to 1 mm, and more preferably from 0.2 to 0.5 mm.

The color converting elements used in the polarizing color converting layer may comprise molecules of a luminescent material or may comprise quantum dots or quantum rods. For example, the color converting elements may comprise an organic luminescent material which is molecularly dissolved in a carrier material, for example a polymeric carrier material. Examples of suitable organic luminescent materials include perylene derivatives, such as Lumogen® F Red 305, Lumogen® F Orange 240, Lumogen® F Yellow 083 and/or Lumogen® F Yellow 170 (all available from BASF). In embodiments corresponding to FIGS. 6 and 7, such organic luminescent material may be molecularly dissolved in the optically anisotropic material and/or the isotropic material.

Other transparent (non-scattering) color converting elements that may be used in the present invention include quantum dots and/or quantum rods . Examples include quantum dots/rods based on cadmium selenide (CdSe) and indium phosphide (InP).

As described above with reference to FIGS. 3-7, the color converting elements may be contained in the optically anisotropic and/or the isotropic domains of the polarizing color converting layer 104, or may be provided as a separate layer.

In embodiments of the invention, the color converting material may be organic luminescent molecules having a dipole moment. In such embodiments, dipole moments of said luminescent molecules may be oriented generally in the same direction as the longitudinal axes of uniaxially oriented optically anisotropic domains. Thus, the luminescent molecules may contribute to polarization of light. Also, in such embodiments, the luminescent molecules may be contained within the optically anisotropic domain(s) 108, 110 of the layer 104, and optionally also within the isotropic domain(s). In embodiments where the luminescent molecules do not have a dipole moment, i.e. are isotropic, the luminescent molecules may be contained in the isotropic domain(s) of the optically anisotropic layer 106 or provided as a separate layer 107. However, it is also contemplated to use a separate color converting layer 107 comprising luminescent molecules having a dipole moment.

The optically anisotropic scattering layer used in the invention may be produced by forming a phase separated blend of two polymers, such as PEN for the anisotropic matrix and PMMA for the isotropic domains, having matching/mismatching refractive indices as described above.

To provide optically anisotropic domains which are macroscopically uniaxially oriented, the polymer intended for the anisotropic domains may be provided as cut fibers dispersed in an isotropic matrix, which subsequently is uniaxially stretched.

The blend is formed into a sheet and stretched to obtain a highly oriented PEN matrix having optical anisotropy, containing domains of isotropic PMMA. Such a layer may be used e.g. in an embodiments as shown in FIG. 5 by adding an isotropic layer comprising the color converting elements. Alternatively, a color converting material such as organic luminescent may be incorporated in the blend during the manufacture so that the color converting molecules are present both in the isotropic and the anisotropic domains. Alternatively, organic color converting molecules may be incorporated into one of the polymers before forming the blend, e.g. covalently attached to PMMA or PEN, respectively, so that the color converting molecules are only present in one of the phases, e.g. the isotropic PMMA phase or the anisotropic PEN phase, respectively.

The lighting device according to the invention may be used in a display, for example liquid crystal displays as used in for example mobile phones, digital cameras, PDAs, gaming devices, other hand-held electronic display devices, control panels, television and computer screens, advertising boards and signs, and more. The type of light-emitting arrangement may be suitably adapted with regard to light source and use of a light guide etc. in consideration of the indented application, such as display area, etc.

The person skilled in the art realizes that the present invention by no means is limited to the preferred embodiments described above. On the contrary, many modifications and variations are possible within the scope of the appended claims.

1. A lighting device, comprising:
a light-emitting arrangement comprising a solid state light source capable of emitting light of a first wavelength range, and having a light outcoupling surface; and
a polarizing color converting layer arranged to receive light that is outcoupled from said light outcoupling surface on one side of the polarizing color converting layer, and comprising i) a color converting element capable of converting light of said first wavelength range into light of a second wavelength range, and ii) at least one region of an optically anisotropic material, and at least one region of an optically isotropic material, wherein said polarizing color converting layer is capable of preferentially scattering one linear polarization direction of light received from the light-emitting arrangement from an opposite side of the one side of the polarizing color converting layer, wherein a predetermined air gap is arranged between the light outcoupling surface and the polarizing color converting layer.

2. A lighting device according to claim 1, wherein the optically anisotropic material shows birefringence and the refractive index of the isotropic material matches one of the ordinary refractive index(n0)and the extraordinary refractive index (ne) of the optically anisotropic material, and mismatches the other one of said ordinary refractive index and said extraordinary refractive index of the optically anisotropic material, such that said polarizing color converting layer is capable of preferentially scattering one linear polarization direction of light received from the light-emitting arrangement.

3. A lighting device according to claim 1, wherein the light-emitting arrangement comprises a light guide plate said light outcoupling surface, and further comprising a rear surface opposite said light outcoupling surface, and at least one (optionally lateral) light incoupling surface, said light guide plate being arranged to receive light emitted by said light source via said at least one light incoupling surface, and to guide said light by total internal reflection.

4. A lighting device according to claim 1, wherein said isotropic material is non-scattering.

5. A lighting device according to claim 1, wherein a plurality of domains of optically anisotropic material are contained in an isotropic carrier material.

6. A lighting device according to claim 5, wherein said domains have shape anisotropy and are uniaxially oriented.

7. A lighting device according to claim 1, wherein domains of isotropic material are contained in an optically anisotropic carrier material showing birefringence.

8. A lighting device according to claim 1, wherein said color converting elements are selected from among nanoparticles of inorganic luminescent material, quantum dots, and organic luminescent material.

9. A lighting device according to claim 1, wherein the color converting elements comprise organic luminescent molecules have a dipole moment and are capable of emitting polarized light.

10. A lighting device according to claim 1, wherein said polarizing color converting layer comprises a first layer comprising said optically anisotropic material and said isotropic material and which is arranged to receive light that is outcoupled from the light-emitting arrangement, and a second layer comprising said color converting elements, said second layer being arranged in optical contact with said first layer.

11. A lighting device according to claim 1, wherein said polarizing color converting layer comprises a single layer comprising said anisotropic material and said isotropic material, and said color converting elements.

12. A lighting device according to claim 1, wherein at least some of said color converting elements are contained in the isotropic region(s).

13. A lighting device according to claim 1, wherein at least some of said color converting elements are contained in said optically anisotropic region(s).

14. A lighting device according to claim 1, wherein said optically anisotropic material comprises a polymeric material, and/or said isotropic material comprises a polymeric material.

15. A backlight system for a display device, said backlight system comprising a lighting device according to claim 14.

16. (canceled)
